(19) United States
(12) Patent Application Publication
(10) Pub. No.: US 2007/0171047 A1
(43) Pub. Date: Jul. 26, 2007

(54) Device and system for locating and providing status of persons, animals or objects

(76) Inventors: Gregory D. Goodman, Briarcliff Manor, NY (US); Evan R. McCall, Sandy, UT (US)

Correspondence Address: AUFRICHTIG STEIN & AUFRICHTIG, P.C., 300 EAST 42ND STREET, 5TH FLOOR, NEW YORK, NY, 10017, US

(21) Appl. No.: 11/339,453

(22) Filed: Jan. 25, 2006

(51) Int. Cl. G08B 1/08; G08B 23/00

(52) U.S. Cl. 340/539.13; 340/573.1

(57) ABSTRACT

A system and method for obtaining location and status information for a person, animal or object. The system, in its various embodiments can include a distributed computer system having more than one databases, and more than one programmed application sets. The databases and programmed application sets can be distributed across more than one physical data centers through an edge server. The system also can include a status device, having one or more component parts in substantially continuous communication with the distributed computer system. The status device can be worn by the person, animal or object, and can communicate the location and status information to the distributed computer system through a virtual private network. The system can also include a locator device, in communication with the distributed computer system through the virtual private network. Thus, an entity desiring to locate the person, animal or object can access the distributed computer system with the locator device through the virtual private network, and the distributed computer system is able to relay the location and status information provided by the status device to the locator device.

### FIELD OF THE INVENTION

This invention relates generally to a device and system that enables a person, animal or object to be identified, located and a status to be determined using state of the art location and tracking technologies.

### BACKGROUND

The last sixty years has included a continual advancement in those technologies that allow for the identification, location, and tracking of people and things. There have been innumerable examples in everyday life, where enormous efforts have been expended by families, law enforcement agencies, and legal bodies to locate persons and more specifically, determine the status of individuals gone missing. A significant number of these situations often end in tragic circumstances.

Over the last ten years, we have seen an increase in both the coordination of location efforts as well as technologies deployed in order to expedite locating persons who have gone missing. The advent of coordinated emergency services such as State and Local “Amber Alert” systems as well as legislated preventative services such as “Code Adam” in New York state, are examples of methodologies being deployed to both respond and prevent these life-critical situations. These solutions place the onus of identifying a critical or “lost person” situation on a human interpretation of the situation and generate efforts using only simplistic and rudimentary technologies such as telephones, data facsimiles, e-mails, and word-of-mouth.

A number of prior solutions have been proposed for use as personal locating systems, as well as systems used as personal alarm and automated dispatch of authorities for persons in critical and emergency situations. For example, U.S. Pat. No. 5,485,163 issued to Singer et al describes a system and method for locating a portable locator device in a communications network. The portable locator unit (PLU) is activated either by an external signal generated in response to remote activation source, such as a subscriber or PLU detector, or by an internal activation signal triggered e.g. by the wearer. Once activated, the PLU transmits a location signal. This location signal is received by one or more network service nodes which forward the information along with identifying service node information to a network location processor. After having determined the location of the PLU from the received information, the network location processor forwards this information to a designated source, such as the requesting subscriber or other authorized user.

U.S. Pat. No. 5,652,570 issued to Lepkofker describes an interactive individual location and monitoring system that includes a central monitoring system for maintaining health, location, and other data with respect to an individual. A watch unit carried by the individual receives medical and other information selected by and inputted directly from the individual. The watch unit broadcasts the medical and other information locally by radio in a region near the individual. A belt worn pod unit is worn by the individual, including a transponder for receiving the information from the watch unit. The pod unit transmits the information to the central monitoring system. The pod unit tracks the location of the individual and transmits the location to the central monitoring system. The pod unit includes a triaxial accelerometer for gathering acceleration data for transmission of the data to the central monitoring station for analysis at a later time. The central monitoring system broadcasts alerts and queries directed to the individual and the transponder pod unit receives and rebroadcasts the alerts and queries locally. The watch unit receives the alerts and queries, and the watch unit includes a vibratory annunciator {sic} which alerts the individual of an inquiry signal from the pod unit.

U.S. Pat. Nos. 5,742,233, 6,239,700, and 6,624,754 issued to Hoffman et al. describe a signaling system comprises a portable signaling unit, a remote alarm switch device, a central dispatch station, and a wireless communication system such as a cellular or telephone system, etc., and a GPS or alike system. The portable signaling unit and the remote alarm switch may be adapted to be worn at different locations on the person's body. The remote alarm switch may be concealed in the form of a wristband or in the form of any other object such as a broach, pendant, or keychain. When the person in distress activates the remote alarm switch or when the remote alarm switch is removed from the individual by a forceful or unauthorized action or when the signaling unit is removed from the proximity of the remote alarm switch, the portable signaling unit sends a data transmission which includes its location to the central dispatch station. The portable signaling unit also has manual alarm trigger capabilities so it can be used without the remote alarm switch unit. The central dispatch station receives the data transmission and accurately displays the user identification, stored personal information, nature of the alarm; in addition the location of the portable signaling unit is superimposed on a digitized map at a position corresponding to the location of the person wearing the portable signaling unit. The portable signaling unit can be remotely activated from a central dispatch station to determine and monitor the location of the portable signaling unit.

U.S. Pat. Nos. 5,905,461 and 6,362,778 issued to Neher describe a global positioning and tracking system for locating one of a person and item of property. The global positioning and tracking system comprises at least one tracking device for connection to the one of the person and item of property including a processing device for determining a location of the tracking device and generating a position signal and a transmitter for transmitting said position signal. The position signal is transmitted to a relay station strategically positioned about a desired monitoring area. The relay station includes a device for receiving the positional signal and determining if the received position signal is a valid signal and a device for relaying the position signal upon determining the position signal is valid to a central monitoring station. The central monitoring station receives the validated positional signal from the relay station and analyzes the position signal for monitoring the position of the tracking device. The system may also include a tracking satellite for receiving the validated position signal from the relay station and re-transmitting the position signal to the central monitoring station when the central monitoring station is located outside the transmission range of the relay station.

U.S. Pat. No. 5,959,533 issued to Layson et al describes a body worn transmitter and its associated portable monitoring receiver receiving global position signals, is provided with tamper detection to support twenty-four hour violation reporting from a subject under community supervision moves about the community. The body worn transmitter incorporates active radio frequency sensors to determine if the body worn transmitter has either been removed from the subject's body or the attachment strap has experienced tampering for the purpose of removal from the subject's body. A signal from the body worn transmitter is encrypted in order to prevent recording and retransmission of the body worn transmitter signal to an associated portable monitoring receiver for the purposes of masking body worn transmitter tampering or to make the body worn transmitter falsely appear in a different location. The body worn transmitter can be immersed in electrolyte solutions without generating a false tamper signal.

U.S. Pat. Nos. 6,014,080 issued to Layson describes a tamper resistant body-worn tracking device to be worn by offenders or potential victims for use in a wireless communication system receiving signals from a global positioning system (GPS). The tracking device directly communicates spatial coordinates to multiple remote sites. The tracking device is an enclosed case worn on a limb of a person. The case contains a battery, a signaling device, and a circuit board containing a field programmable gate array, a wireless data modem, a conventional GPS receiver, and a matched filtering GPS receiver.

U.S. Pat. No. 6,172,640 issued to Durst et al. describes an object locator system for requesting and obtaining information about the location of an individual animal or moveable object, having a lightweight, attached object locator, that is present in a region served by a two-way paging system and a global positioning satellite system. The object locator may be selectively activated to conserve power or enabled to respond only when beyond or within a boundary. Further, the object locator system may provide the location information in several forms including rectangular or polar coordinates referred to a base station or origin, position on a map display, etc.

U.S. Pat. No. 6,720,879 issued to Edwards describes an animal collar for locating and tracking animals. The animal collar is provided with a digital video camera that may be remotely controlled transmit real time full motion video signals over a broadband wireless communication network to allow a pet owner to view the immediate surroundings of a lost pet. The animal collar is further provided with a global positioning (GPS) unit that communicates with GPS satellites to determine the geographic coordinates of the animal collar.

U.S. Pat. No. 6,788,200 issued to Jamel et al describes a locator unit contained within footwear providing a method for GPS position determination and transmission of said location determination data to a central monitoring station which disseminates the data through the use of proprietary software, wireless communications, land based wire systems and the Internet.

U.S. Pat. No. 6,838,998 issued to Brown et al. describes an Internet based personal tracking system for tracking the position of a portable location unit by a remote user comprising a web host connected to the Internet having a computer storage medium, a portable location unit having a processor for receiving geo-position information, and generating geo-position data representing the position of said location unit, a transceiver included in said location unit for transmitting said position signal to said web host in response to a call signal being received from said web host, a power supply for supplying power to said processor and said transceiver; and a computer program residing on said web host having an input module for receiving a tracking request signal from the remote user via the Internet, a processing module for processing said tracking request signal, and a communication module for initializing communication with said location unit in response to tracking said request signal, and a location module for outputting said call signal to said location unit and for receiving said geo-position data from said location unit; and a display module for outputting said position dataset to the remote user via the Internet for display of the location unit's position at the remote user's site.

All the foregoing patent references are hereby incorporated by reference for their supporting teachings.

Nevertheless, each of the foregoing systems is inadequate in many respects. For example, many of them are directed at locating, tracking, and providing for the immediate response by third-party agencies for emergency or out-of-tolerance/boundary situations, and include an alarm-trigger feature based on tracking information. This is an explicit mode that requires an active decision by a human or is merely a result of programmed application logic. Moreover, none of the foregoing adequately provide for a system that is able to continuously locate, track and provide a status of the wearer. In other words, a state of “Normal” in connection with the individual or object is passively assumed, as opposed to being actively and explicitly reported.

In addition to the state of the device, normal or in alarm, consideration must be given to the overall complexity of the system. Significant technology coupled with the infinite variables associated to human behavior, whether in a state of emergency or not, would preclude an ability to take into consideration and program for all possible events. Even a fairly passive situation of simple device removal is full of potential scenarios that do not fall within the categories of emergencies, distress, or even criminal intent. It is foreseeable that frequent and repeated initiation of the various manual and system generated alarms could cause a the desensitization of the overall value of such alerts and eventually result in a situation where the frequency of “false” alarms leads to the ignoring of the alarms. The systems described above are too complex, focused on responding to distress situations, and require a significant degree of wearer interaction to function.

Additional problems with the prior art are that some systems limit the amount and type of data and information that is provided to discrete solution sets. This is problematic because limiting data communication to only a few elements inhibits and in many cases prevents such systems from supporting or being deployed in those situations that require adherence to multiple International Data Standards. Moreover, under such limitations, actual information content of the transmission interfaces cannot be in compliance with the construct and format of such interfaces with the various and pertinent International Organization of Standardization air interface, data, and quality standards. Additionally, the prior art is not adequately interoperable with those computer systems that are already deployed for identification and status solutions.

Another problem with prior art systems is their lack of use of current technologies providing for efficient, effective and time sensitive acquisition, processing, storing, and retrieval of information, such as those situations where the basic functionality of locating a person is time critical, such as child abductions, from a central application set of centrally located application sets. A feature contained within one embodiment of the present invention is the use and deployment of a Distributed Computer System. A Distributed Computer System is a network of independent computers and computing devices that are connected in such a way that any computer or device in the system can communicate with and potentially share data, programs, or other resources communicated with any other computer or device in the system. This technology is better over the prior art in that this technology provides higher levels of transmission speeds and information security, and large gains in overall database operational efficiencies related to logical data processing, writing data to the database(s), storing data within the database(s), reading data from the database(s), extracting pertinent data from the database(s), and displaying data in multiple formats to multiple devices through the means of assigning computer readable code based on the required functionality of any particular element within the distributed system.

An additional problem with the prior art is that many of these systems utilize the World Wide Web and Internet to facilitate communications between location devices and a remote center that maintains the computer readable code required to receive, store, interpret, display, and generally manage raw data derived from the literal location device. Recent technological advances in the art of data and application management allow a methodology that provides for data processing and information management to move away from less efficient centralized data storage and processing and transmission of data through the public switched Internet environment, to that of a distributed network of computer readable code wherein only that code required to perform predefined logical processes relative to the actual device, or processes providing for different components and objects comprising an application in total, are located on different computers utilizing Edge Server technology. The use of Edge Server technology is a feature within one embodiment of this invention. Edge Server technology differs significantly from previous art for data processing and transmission, in that Edge Server technology bypasses the Internet itself providing higher levels of transmission speeds and information security, and large gains in overall data management efficiencies.

In addition, another problem with the prior art is the limitation of identification and communication protocols related to the use of the public world wide Internet. The use of a Virtual Private Network is a feature within one embodiment of this invention that improves what has been taught in previous art by delivering enhanced data and transmissions security, increased control and monitoring capabilities related to transmission pathways, reduced costs for data communication transmission and control equipment, overall solution scalability, and flexibility in the use and deployment of data transmission protocol.

In short, the present invention, in its various embodiments, solves each of the foregoing problems in the prior art, as well as others, and provides a system that can create, utilize, and integrate a set of technologies that allows for the immediate identification, location, and status of a device worn by an individual and can be used as a mechanism of identification and location in both emergency and non emergency situations.

### SUMMARY OF THE INVENTION

Therefore, there is provided, a system for obtaining location and status information for a person, animal or object. The system, in its various embodiments can include a distributed computer system having more than one databases, and more than one programmed application sets. The databases and programmed application sets can be distributed across more than one physical data centers through an edge server. The system also can include a status device, having one or more component parts in substantially continuous communication with the distributed computer system. The status device can be worn by the person, animal or object, and can communicate the location and status information to the distributed computer system through a virtual private network. The system can also include a locator device, in communication with the distributed computer system through the virtual private network. Thus, an entity desiring to locate the person, animal or object can access the distributed computer system with the locator device through the virtual private network, and the distributed computer system is able to relay the location and status information provided by the status device to the locator device.

In one embodiment, the status device is a wristband. In another embodiment, the status device is a pendant. In another embodiment, the status device is a smart card. In yet another embodiment, the status device is an earring.

The system can also include a central support center, which bridges the communication between the locator device and the distributed computer system. The central support center can be staffed by one or more center operatives.

In one embodiment the locator device is a computer. In another embodiment, the locator device is a telephone. In another embodiment, the locator device is a cellular phone. In yet another embodiment, the locator device is a personal digital assistant (PDA).

The status device can also include one or more non-component parts. The component parts can be things such as a GPS antenna array, a GPS processor, a CPU/Power microprocessor, and a communication processor. The status device can also include a battery.

A method for providing location and status information for a person, animal or object to a searching entity is also provided. The method involves providing a distributed computer system having more than one databases; and more than one programmed application sets. As noted above, the databases and programmed application sets can be distributed across more than one physical data centers through an edge server. A status device is affixed to the person, animal or object. The status device can include one or more component parts in substantially continuous communication with the distributed computer system, and it can communicates the location and status information to the distributed computer system through a virtual private network. A locator device that is in communication with the distributed computer system through the virtual private network is provided to the searching entity. A request for the status and location information is then made to the distributed computer system, and the locator device receives the requested status and location information, such that it is available to the searching entity.

Some features and advantages of the various embodiments of the present invention as taught herein include, but are not limited to, the following:

They provide a system that makes available to a consumer all data and information necessary and inclusive of certain stored information to identify the location, time, and status of the status device and to maintain that data necessary to associate the device to a person, animal or object.

They provide a computer system capable of identifying a unique individual, group of individuals, or business entity and acquiring and maintaining all information necessary to associate a single or multiple devices to that individual, group of individuals, or business entity through the use and deployment of Edge Server technology.

They provide a distributed computer system that provides for the encryption and secure control of all login access, data content, or data removal for an unique individual, group of individuals, or business entity.

They provide a distributed computer system that provides for the ability for an unique individual, group of individuals, or business entity to establish, edit, and maintain a many-to-many association of status devices to persons or objects at the device level.

They provide a distributed computer system that allows an unique individual, group of individuals, or business entity to select and view location, time, and status information on a single status device or multiple devices for either a single current state or complete historical states.

They provide a distributed computer system capable of acquiring, storing, and displaying the location, time and status of a person, animal or object to which the status device has been attached or associated in a convenient, efficient manner, including both current and historical information that provides for the continuous tracking and status of the device.

They provide a distributed computer system that includes the visual mapping of both current and historical information that provides for the continuous tracking and status of the device such that a person can easily and intuitively identify the physical geographic local of the person or object to which a status device has been associated.

They provide a distributed computer system with the means by which a person can immediately initiate the continuous communication and tracking of a status device.

They provide a distributed computer system with the means by which a person can transmit and receive all information, instructions or communications utilizing a private data network that makes use of a commercial telecommunication infrastructure, providing for privacy through the use of a tunneling protocol and security procedures and bypassing and communicating by means other than the World Wide Web or Internet. This technique and art is otherwise known as a Virtual Private Network.

They provide a distributed computer system with the means by which a person can transmit and receive all information, instructions or communications utilizing a telephone system to connect to the Virtual Private Network.

They provide a distributed computer system with the means by which a person can transmit and receive all information, instructions or communications utilizing a cellular telephone connected to a wireless communication infrastructure to connect to the Virtual Private Network.

They provide a distributed computer system with the means by which a person can transmit and receive all information, instructions or communications utilizing a hand held personal computer connected to a wireless or cable communication infrastructure to connect to the Virtual Private Network.

They provide a distributed computer system with the means by which a person can transmit and receive all information, instructions or communications utilizing a computer connected to a wireless or cable communication infrastructure to connect to the Virtual Private Network.

They provide a distributed computer system comprised of a number of independent and uniquely identified devices which contain all or part of the data, components, and processes specifically designed for streaming data over a Virtual Private Network bypassing the world wide Internet, utilizing the means by which an Edge Server deployed within the Virtual Private Network can immediately initiate the continuous communication and tracking of a status device.

They provide a distributed computer system with the means by which an Edge Server deployed within the Virtual Private Network can transmit and receive all information, instructions or communications utilizing a Virtual Private Network, bypassing and communicating by means other than the World Wide Web or Internet.

They provide a distributed computer system with the means by which an Edge Server deployed within the Virtual Private Network can transmit and receive all information, instructions or communications utilizing a wire-based telephone system to connect to the Virtual Private Network.

They provide a distributed computer system with the means by which an Edge Server deployed within the Virtual Private Network can transmit and receive all information, instructions or communications utilizing a cellular telephone connected to a wireless communication infrastructure to connect to the Virtual Private Network.

They provide a distributed computer system with the means by which an Edge Server deployed within the Virtual Private Network can transmit and receive all information, instructions or communications with a hand held personal computer connected to a wireless or cable communication infrastructure to connect to the Virtual Private Network.

They provide a distributed computer system with the means by which an Edge Server deployed within the Virtual Private Network can transmit and receive all information, instructions or communications with a computer connected to a wireless or cable communication infrastructure to connect to the Virtual Private Network.

They provide a central support center computer system that makes available to all authorized central support center personnel all data and information necessary and inclusive of certain information stored throughout the network of distributed Edge Servers to an unique individual, group of individuals, or business entity to establish, edit, and maintain a many-to-many association of status devices to persons or objects.

They provide a central support center computer system that makes available to all authorized central support center personnel all data and information necessary and inclusive of certain information stored throughout the network of distributed Edge Servers to identify the location, time, and status of the status device and to maintain that data necessary to associate this device to a person or object.

They provide a central support center computer system that makes available to all authorized central support center personnel an ability to ascertain an abnormal status of a status device including all data, location, time and status information stored throughout the network of distributed Edge Servers.

They provide a central support center computer system that makes available to all authorized central support center personnel an ability to initiate those steps necessary to communicate the abnormal status of a status device to the appropriate individual, group of individuals, business entity or designated agency including all data, location, time and status information stored throughout the network of distributed Edge Servers.

They provide a central support center computer system that makes available to all authorized central support center personnel an ability to initiate those steps necessary to communicate the abnormal status of a status device to the appropriate individual, group of individuals, business entity or designated agency including all data, location, time and status information stored throughout the network of distributed Edge Servers.

They provide a central support center computer system with the means by which all authorized central support center personnel can transmit and receive all information, instructions or communications utilizing the Virtual Private Network.

They provide a central support center computer system with the means by which all authorized central support center personnel can transmit and receive all information, instructions or communications utilizing a telephone system to connect to the Virtual Private Network.

They provide a central support center computer system with the means by which all authorized central support center personnel can transmit and receive all information, instructions or communications utilizing a cellular telephone connected to a wireless communication infrastructure to connect to the Virtual Private Network.

They provide a central support center computer system with the means by which all authorized central support center personnel can transmit and receive all information, instructions or communications utilizing a hand held personal computer connected to a wireless or cable communication infrastructure to connect to the Virtual Private Network.

They provide a central support center computer system with the means by which all authorized central support center personnel can transmit and receive all information, instructions or communications utilizing a computer connected to a wireless or cable communication infrastructure to connect to the Virtual Private Network.

They provide a central support center computer system with the means by which all authorized central support center personnel can obtain and read the complete history of data for an individual, group of individuals or business entity via the Virtual Private Network.

They provide a distributed computer system with the means by which all data pertaining to status devices, individuals, groups of individuals or business entities can be acquired, transformed, processed, stored, modified, deleted, and extracted via the Virtual Private Network.

They provide a distributed computer system with the means by which all data can be communicated into and out of the distributed computer system using a Virtual Private Network.

They provide a distributed computer system with the means by which all data can be communicated into and out of the distributed computer system using commercially available domain and object naming services for the purposes of data transmission routing, acknowledgement, and security throughout the distributed network.

They provide a distributed computer system with the means by which all data can be communicated into and out of the distributed computer system using proprietary Virtual Private Network comprising in part commercially available telecommunications services and structures.

They provide a distributed computer system with the means by which all data communicated into and out of the distributed computer system utilizes advanced data encryption and security methodologies and mechanisms to ensure the control and authorize access to readable data content.

They provide a distributed computer system with the means by which all data can be stored in a retrievable format and media external to the physical location of the Edge Server nodes throughout the distributed computer system.

They provide a distributed computer system with the means by which all data stored throughout the system utilizes advanced data encryption and security methodologies and mechanisms to ensure the control and authorize access to readable data content.

They provide a computer system with the means by which all data can be stored in a retrievable format and media external to the physical location of the Edge Server nodes throughout the distributed computer system.

They provide a distributed computer system with the means by which a single status device and can be periodically interrogated as to location, time, status, and other variables, regardless of the location or node of that device on the distributed computer system.

They provide a distributed computer system with the means by which a status device response can be received which includes time, status and other variables.

They provide a distributed computer system with the means by which a status device and can be continuously interrogated as to location, time, status, and other variables.

They provide a distributed computer system with the means by which a status device and can be periodically interrogated as to overall health of the status device.

They provide a means for locating, tracking and determining status of a device worn by a person or attached to an object.

They provide a small, wearable, attachable status device.

They provide a status device that can be worn by, attached to, or carried by a person or object such that the status device does not hinder or alter the movements or intended use by a person or of an object.

They provide for the acquisition and processing of global position satellite signals.

They provide for the acquisition and processing of cellular communication signals within a proprietary Virtual Private Network.

They provide for the acquisition and processing of human biometric signals in the forms of temperature, heartbeat, electroencephalogram, and electrocardiogram signals for determining the proximity of the status device to the person or object.

They provide for the acquisition and processing of radio frequency identification signals across all radio transmission frequencies including but not limited to 2.5 Ghz, 13 Mhz, 915 Mhz, and 125 Mhz for the purposes of uniquely identifying a person or an object.

They provide for the circuits and logic within the status device to remain off or dormant when not in active use.

They provide for the circuits and logic within the status device to manage battery power.

They provide for the circuits and logic within the status device to monitor the on board battery power and alert a predetermined node of the distributed computer system when battery power is at a predetermined discharge level.

They provide for the status device to automatically generate an unique and final transmission when battery power is completely consumed.

It is noted that the various embodiments of this invention are capable of locating, tracking and providing status information for persons, animals and/or objects.

The various embodiments of the invention described herein can also easily be integrated into and made compatible with the numerous agencies and organizations having automated missing persons systems such as Amber Alert. Also, the ability to integrate location, time, and status information into commercial transportation, track and trace, and other enterprise-wide applications and application suites is a feature of this invention.

Other advantages and features of the invention described and claimed herein will become more apparent from the following illustrations and detailed description of the illustrative embodiments.

### BRIEF DESCRIPTION OF THE DRAWINGS

FIG. 1 is a schematic of a personal location, tracking and status system according to one embodiment of the present invention;

FIG. 2 is a perspective drawing of a status device which is included in the personal location, tracking and status system of FIG. 1;

FIG. 3 is a perspective drawing of the various components contained within the status device of FIG. 2 according to one embodiment of the present invention;

FIG. 4 is a block diagram of the distributed computer system showing the functional components to be deployed by one embodiment of the present invention;

FIG. 5 is a block diagram of the Virtual Private Network which transports data between a status device (e.g. as depicted in FIG. 2) and distributed computer system (e.g. as depicted in FIG. 4);

FIG. 6 shows various scenarios and methods of the activities and information exchanged between the status device of FIG. 2 and distributed computer system FIG. 4 as transmitted throughout the Virtual Private Network FIG. 5 according to one embodiment of the present invention.

### DETAILED DESCRIPTION OF DRAWINGS

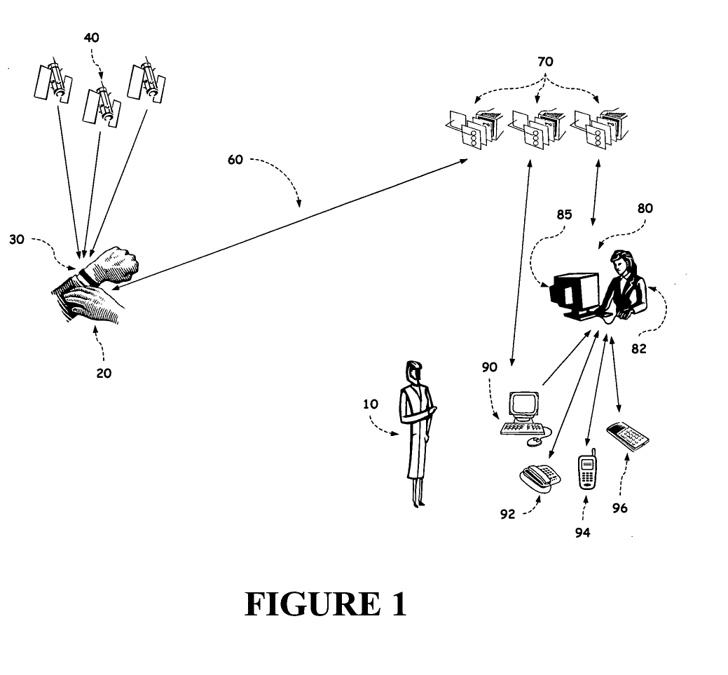

Referring to FIG. 1, the device and system for locating and providing the identification and status of persons according to the present invention, generally includes an individual, group of individuals or business entity 10 that has determined a need to acquire and deploy a system for locating and providing the status of persons 20, animals, or inanimate objects. These procedural and modular descriptions and representations are the means used by those skilled in the art to most effectively convey the substance of their work to others skilled in the art.

The device and system for locating and providing status of persons generally includes a status device 30 shown here in a configuration of a wristband. The status device 30 can be worn or carried by a person 20 being tracked or attached to an animal or object. It should be appreciated that the status device can be attached to or assigned to persons, animals or other objects. Hence, the present invention should not be construed as limited to persons.

The device and system for locating and providing status of persons shown in FIG. 1 employs, a Virtual Private Network 60 that may include in part, a commercially available global telecommunications system or network, that incorporates cellular and wireless technologies for the purposes of performing transmissions and communications between the status device 30 and distributed computer system 70. This Virtual Private Network 60 provides secondary or backup status device location that may be substituted hereto in the event that the distributed computer system 70 receives an indication that the status device 30 is in communications within a segment of the Virtual Private Network 60 or at a node of the telecommunications system but no current location coordinates or other status data have been included in the basic transmission. This Virtual Private Network 60 is a feature within one embodiment of this invention that improves what has been taught in previous art by delivering enhanced data and transmissions security, increased control and monitoring capabilities related to transmission pathways, reduced costs for data communication transmission and control equipment, overall solution scalability, and flexibility in the use and deployment of data transmission protocol.

The Virtual Private Network 60 provides a secure, low cost, scalable transmission means for information communication between the status device 30 and distributed computer system 70. It should also be appreciated by one skilled in the art that communication devices, such as Wi-Fi, Wi-Max, Bluetooth, are used as mechanisms within the Virtual Private Network 60 for transmitting data between any two machines or computer systems, and to the extent that these devices are used within the Virtual Private Network 60, are therefore interchangeable.

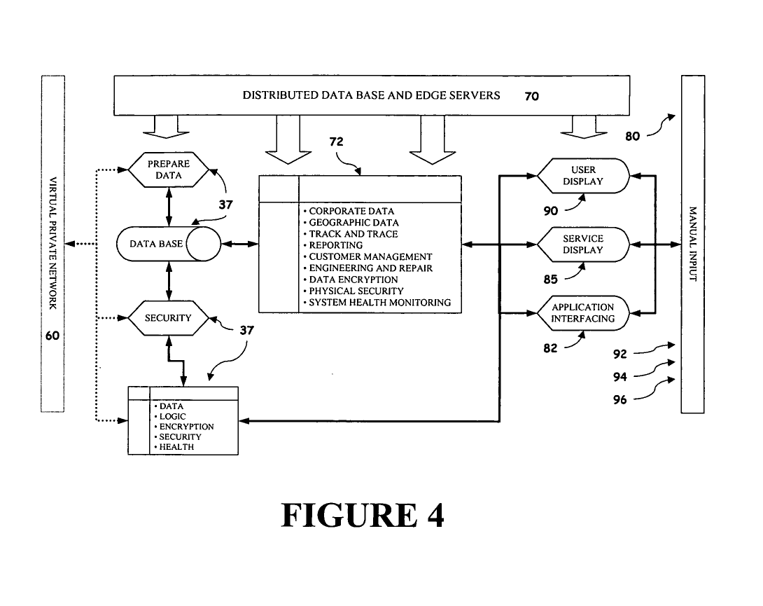

The device and system for locating and providing status of persons shown in FIG. 1 employs a distributed computer system 70. This computer system 70 provides a data base and programmed application sets 72 (FIG. 4) constructed for and comprising the means for creating, adding to, deleting from, extracting, reporting, and maintaining all information related to the present invention and are in the form of computer readable code. These data base and application sets 72 are distributed across various physical data centers and devices through the use of Edge Server technologies which are better over what is used in the prior art in that this technology bypasses the Internet itself providing higher levels of transmission speeds and information security, and large gains in overall data base operational efficiencies related to logical data processing, writing data to the database(s), storing data within the database(s), reading data from the database(s), extracting pertinent data from the database(s), and displaying data in multiple formats to multiple devices. A number of suitable data encryption programs incorporating secure access algorithms and other programming features are commercially available and suitable for use with the present invention.

The distributed computer system 70 is accessed in a fully secure manner by individuals, groups of individuals, and business entities 10. A number of suitable access programs incorporating secure access algorithms and other programming features are commercially available and suitable for use with the present invention. A feature of a distributed computer system 70 that improves on prior art, and is in one embodiment of the present invention, is the encryption and secure control of all login access, data content, or data removal for an unique individual, group of individuals, or business entity is provided for within any or all sub systems or components of the distributed computer system, thus providing multiple, flexible security access and controls.

The methods of access to the distributed computer system 70 employs, as part of the Virtual Private Network 60, computers 90, telephones 92, cellular telephones 94, and personal digital assistants 96 connected to the Virtual Private Network 60 via modem, wire, radio signals or other wireless technologies for the purposes of performing transmissions and communications with the distributed computer system 70.

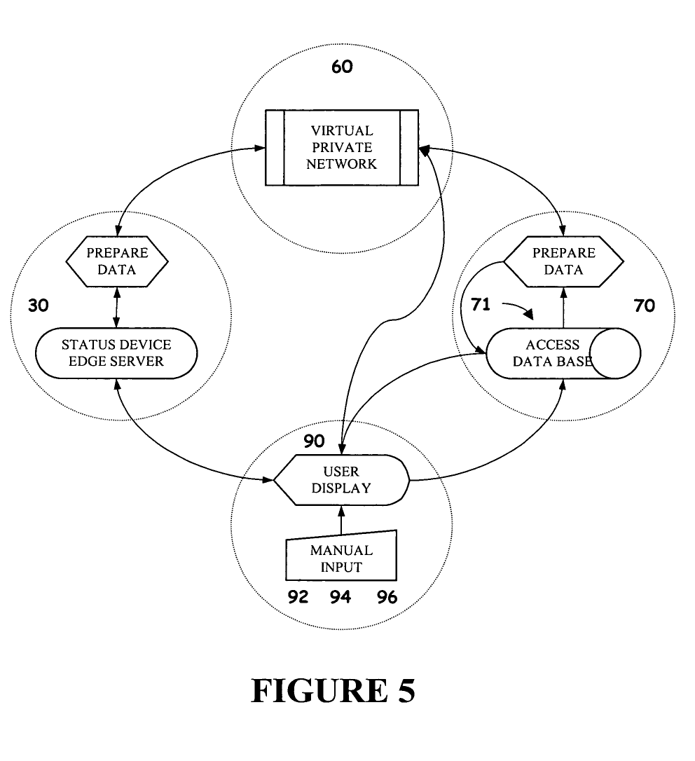

As disclosed in FIG. 4 and FIG. 5, sections of computer readable code 37, 72, 82 are designed to perform a specific task or tasks and may be physically resident in different locations 30, 70, 90 and on different physical devices 30, 70, 90 as integral parts of the distributed computing network. Actual computer executable code need not be contained with one file or one storage medium or within a central computer system or web host to constitute any single section 72. Sections 30, 37, 72, 82 generally receive input and provide output. The sections 30, 37, 72, 82 may receive information passed by another calling section or Edge Server 30, 37 and may output information to the calling section or any other section.

A distributed computer system 70 is computer hardware capable of creating and processing computer readable instructions and is better over what is taught in the prior art in that a distributed system 70 is not limited to a single computer or device. This is advantageous because a centralized computer system imposes by definition a taxonomy of a system single computing instruction, single data. For example, mass storage, network communications, and main processing could be executed by three physically separate computers and would still constitute elements of a distributed computer system. This many-to-many computing taxonomy provides for multiple computing instructions and multiple data to be processed by different computers or devices throughout the distributed system, thus minimizing response times and maximizing throughput of the overall system. Therefore, the term “distributed computer system” is not intended to be limited to a single computer or any single set of computer readable code.

The device and system for locating and providing status of persons shown in FIG. 1 employs a central support center 80. The central support center 80 is staffed by one or more support center operatives 82 and employs computers 85, telephones 92, cellular telephones 94, and personal digital assistants 96 connected to the Virtual Private Network 60 via modem, wire, radio signals or other wireless technologies for the purposes of performing transmissions and communications with individuals, groups of individuals, or business entities 10 having acquired and deployed the status device 30 and the distributed computer system 70.

The central support center operatives 82 access the distributed computer system and are provided the means for creating, adding to, deleting from, extracting, and maintaining all information related to the present invention. In addition to the operation of the distributed computer system 70 the central support center operatives 82 are enabled to communicate directly with those individuals using or having deployed a status device 30 employing computers 85, telephones 92, cellular telephones 94, and personal digital assistants 96 and the various applications and functionalities associated to these devices, in example, e-mail, text messaging, chat sessions, audio and video streaming, or any other mechanism or method commercially available that enables bi-directional communications.

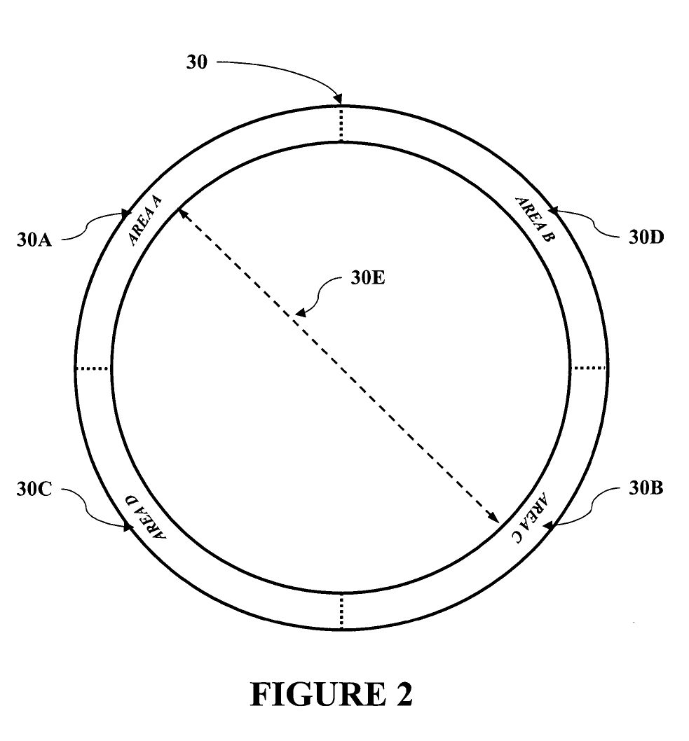

FIG.2 shows one embodiment of a status device 30 in the form of a wristband assembly constructed in such a manner as to have multiple inside diameter dimensions 30e. The status device can be in the form of any object, such as a pendent, smart card, or earring. Regardless of the construction, the status device 30 comprises multiple sections 30a, 30b, 30c, and 30d for purposes of segregating critical components. These sections together form the outer casing and enclosure of the status device 30 and provide for the containment of modular components and devices situated in such a manner as to enable the removal, replacement, and insertion of components as deemed necessary. In addition to component segregation, certain sections of the status device 30 are designated as sections that contain no components. Such a designation provides flexibility of future component designations by section and overall elasticity of the status device 30 itself.

The sections 30a, 30b, 30c, 30d in their entirety may be molded of plastic material, resins, or other synthetic or natural materials, is waterproof, and may be constructed in such a manner as to preclude materials that have been deemed toxic to people, animals or the environment. The sections 30a, 30b, 30c, 30d are fabricated such that the status device 30 can be easily and readily attached to an appendage of the body preferably ones wrist, by slightly stretching the casing and sliding the entire status device 30 onto the wrist or other appendage.

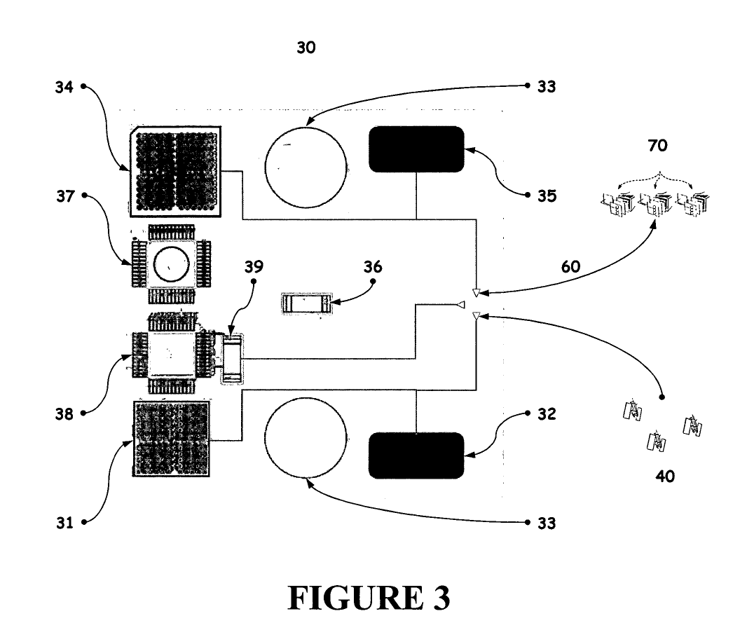

FIG. 3 illustrates one embodiment of a status device 30 in the form of a wristband assembly in greater detail. The status device 30 includes the aforementioned outer casing and enclosure inclusive of the method and mechanisms for mounting and connecting those components illustrated in FIG. 2.

The status device 30 can include a variety of components including, but not limited to, a GPS antenna array 31 which receives the GPS ranging signals transmitted from the GPS satellites 40 positioned in the sky above the status device 30. The GPS antenna array 31 may be any GPS antenna array configured for use in and tuned to the precise configuration of the status device 30. One example of a suitable GPS antenna array is the SPK-LT-548SMP antenna, available from SPK Electronics Company, LTD. This antenna array 31 is constructed such that the radio frequencies in the form of signals generated by the GPS satellite network are enabled to receive at least three ranging signals as is well known in the art. The GPS processor 32 located within and mounted to the status device 30 receives the GPS signals from the GPS antenna 31. The GPS receiver 32 is a simplified microprocessor receiving chip that is configured using logical programming code to enable the processing of GPS signals from the GPS satellites 40 in such a manner as to determine encoded spatial coordinates of longitude, latitude, and altitude in relationship to a specific geographical and spatial location on and within the earth's habitable boundaries.

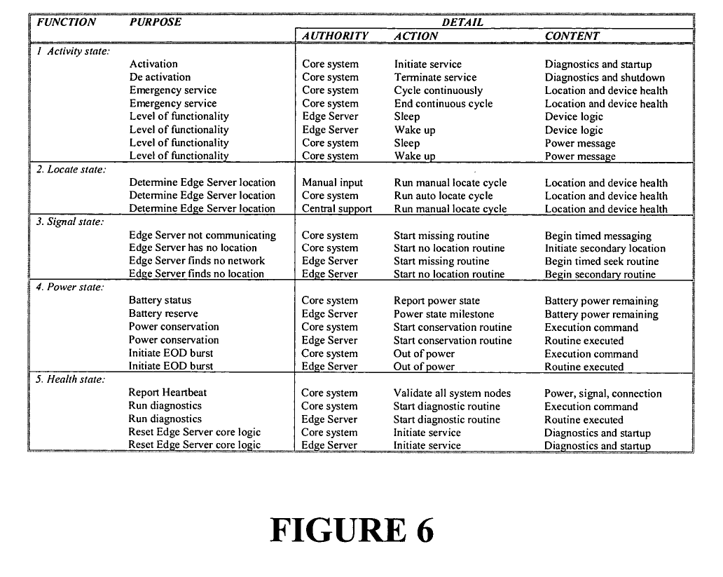

In addition to the aforementioned functions, the GPS processor 32 enables certain pre-defined logical processes that provide control of the execution of certain functions described in FIG. 6. As would be apparent to one of ordinary skill in the art, the GPS processor 32 employs control of these pre-defined logical processes through the configuration of certain variables and mechanisms inherent to the design and commercial nature of the GPS processor 32. A number of suitable GPS processors incorporating all necessary programming features as described within this embodiment and specifically as shown in FIG. 6 are commercially available and suitable for use with the present invention such as the STMicroelectronics STA2056 Palinuro GPS microchip. Hence, the present invention should not be limited to any single manufacturer or commercially available GPS processor.

Additional features of the status device 30 and components include power provided by a battery or set of batteries 33 (FIG. 3). The battery or batteries 33 are preferably long life battery comprised of lithium or thin-film battery technology. It is also noted that the battery or batteries 33 may be in the form of a rechargeable battery, non-rechargeable battery, or battery powered by renewable power sources such as solar power. In such case where the battery or batteries 33 are no longer able to generate sufficient power to enable the operation of all components of the status device 30 a unique and specific logical routine will be generated by the CPU/Power processor 37 with embedded Edge Server capabilities and transmitted to the distributed computer system 70 indicating the end of battery life of the status device 30. A number of suitable batteries incorporating all necessary features as described within this embodiment and specifically as shown in FIG. 3 are commercially available and suitable for use with the present invention. Examples of suitable batteries include, but are not limited to, the ML1220 magnesium lithium battery manufactured by Panasonic or the US2025 lithium battery manufactured by Sony. Hence, the present invention should not be limited to any single manufacturer or commercially available battery or power supply.

In addition to the battery or batteries 33 supplying power to the status device 30 a CPU/Power microprocessor 37 is employed to monitor, regulate, and control the flow and use of power within the status device 30 and all components utilizing power as illustrated in FIG. 3. As would be apparent to one of ordinary skill in the art, the CPU/Power 37 includes Edge Server technology and employs numerous pre defined logical processes which provide control of the use of both components and power within the status device 30 and all components utilizing power as illustrated in FIG. 3 through the configuration of certain variables and mechanisms inherent to the design and commercial nature of the CPU/Power processor 37 with embedded Edge Server capabilities. A number of suitable CPU/power processors 37 incorporating all necessary programming features as described within this embodiment and specifically as shown in FIG. 3 are commercially available and suitable for use with the present invention such as the Texas Instruments OMAPV1030 Edge solution ship sets. Hence, the present invention should not be limited to any single manufacturer or commercially available CPU and power regulators.

In additional to the other components illustrated in FIG. 3 the status device 30 employs communication processors 34, 38 for the purposes of enabling bi-directional communications between the status device 30 and the Virtual Private Network 60. The cellular GSM/GPRS/CDMA transceiver module 34 or the wireless broadband signal processor 38 enables bi-directional communications. The process by which the GSM/GPRS/CDMA transceiver module 34 or the wireless broadband signal processor 38 communicate with the Virtual Private Network 60 is initiated and controlled by the coded program logic in the distributed computer system 70, the CPU/Power processor 37 with embedded Edge Server capabilities, and the GPS processor 32 enabling communications described in FIG. 6.

A pre-determined logical process contained within the GSM/GPRS/CDMA transceiver module 34 selects the method and component that is used for any given communication session between the status device 30 and Virtual Private Network 60. The GSM/GPRS/CDMA transceiver module 34 employs certain pre defined logical process programs that provide control of the communications as illustrated in FIG. 6. By configuring certain variables and mechanisms inherent to the design and commercial nature of the GSM/GPRS/CDMA transceiver module 34 communications with the Virtual Private Network 60 are controlled. A number of suitable GSM/GPRS/CDMA transceiver modules 34 incorporating all necessary programming features as described within this embodiment and specifically as shown in FIG. 6 are commercially available and suitable for use with the present invention such as the Infineon Technologies PMB7850 GSM chip sets. Hence, the present invention should not be limited to any single manufacturer or commercially available GSM/GPRS/CDMA transceiver modules 34.

The wireless broadband signal processor 38 employs certain predefined logical process programs that provide control of the communications as illustrated in FIG. 6. By configuring certain variables and mechanisms inherent to the design and commercial nature of the wireless broadband signal processor 38 communications with the Virtual Private Network 60 are controlled. A number of suitable wireless broadband signal processor modules 38 incorporating all necessary programming features as described within this embodiment and specifically as shown in FIG. 6 are commercially available and suitable for use with the present invention such as the Agere WL1141 PHY. Hence, the present invention should not be limited to any single manufacturer or commercially available wireless broadband signal processor modules.

The methods and processes by which this invention employs the reception, processing, storage, retrieval, presentation, and transmission of data information is consistent with the logical computer readable code typically used in software applications architectures as disclosed in the distributed computer network 70.

As seen in FIG. 5, the primary items and entities of this invention related to the data processing include the individual, group of individuals or business entity 10 and those devices and mechanisms used for both the display of information, graphics, audio or video and manual input or information 90, 92, 94, 96, the computer system 70 and computer readable codes and system applications 72 and storage and data processing Edge Server capabilities with the CPU/Power processor 37 with embedded Edge Server capabilities that receive, process to logic, store and transmit information, the Virtual Private Network 60 receives and transmits information between the distributed computer system 70 and CPU/Power processor 37 with embedded Edge Server capabilities located onboard the status device 30.

An item or entity as herein described is generally a self-consistent sequence of tasks leading to desired results. These tasks are those requiring physical manipulations of physical values. Usually, these physical values take the steps of electrical or magnetic signals capable of being stored, transferred, combined, compared or otherwise manipulated.

More specifically, an item or entity is a section of computer readable code that is designed to perform a specific task or tasks. Actual computer executable code need not be contained with one file, on one storage medium, or in a common central location to constitute an item or entity. Items or entities generally receive input and provide output. The items or entities may receive information passed by another initiating item or entity and may output information to the item or entity.

An user display 90 used for manual input of data 92, 93, 94, is computer hardware device capable of creating and processing computer readable instructions and is not limited to a single computer. For example, mass storage, network communications, and main processing could be executed by three physically separate computers located in three distinct and distant geographical locations and would still constitute an user display 90 used for manual input of data 92, 93, 94. Therefore, the term “user display” 90 is not intended to be limited to a single computer or computing device.

Data elements are electronic messages or information together with a globally unique address identifier which are sent as a single unit. Unique address identifiers can be any of a number of identifiers including but not limited to IEEE number, cellular telephone number, static IP address, IPv6, or proprietary value. It should also be appreciated by one skilled in the art that any type of communication devices is assigned an unique identification number. It should be further appreciated that the use of unique identification protocols are required by specific communication entities such as IP addresses throughout the World Wide Internet. The use of a Virtual Private Network 60 by this invention precludes such requirements for a single, common globally unique address of personal identifier and is better than what is taught in the prior art because information content of the transmission interfaces of this invention comply with the construct and format of such interfaces with the various and pertinent International Organization of Standardization relative to global identification, message and device uniqueness, and functional use within the application set.

Referring again to the drawings, the operation of the present embodiment will now be described in further detail. As seen in FIG. 1, the system includes a distributed computer system 70 connected to the Virtual Private Network services 60 and connected to the status device 30. Computer programs control the distributed computer system 70 and receive input from a concerned user 10 through the use of various and multiple computer hardware devices 92, 93, and 94.

To initiate a request for the status and location of a status device 30, and thus, the person or object 20 to which the status device is attached or assigned, the distributed computer system 70 receives a computer readable code created by an individual 10, the customer support operator 82, or from automated routines from within the system itself 70, from the CPU/Power processor 37 with embedded Edge Server within the status device 30 itself instructing the computer system 72 to generated an interface containing at a minimum, the binary coded instructions to execute those capabilities as disclosed in FIG.6.

The computer system employs computer readable code to access the data bases 72, access, aggregate and construct the necessary data elements and instruction sets in a format and construct such that an interface is prepare which is readable by the Virtual Private Network 60, requesting the location and status data for making the same available to the concerned user, as more fully described below.

This interface is then delivered to the Virtual Private Network 60 employing those codes and content such that the Virtual Private Network is enabled to locate a specific and unique status device 30 within the geographical boundaries of that same network, and deliver to the antenna array 35 of the specific status device 30 the interface and data elements generated as above.

The mode, selection, literal routing of the interface message created by the distributed computer system 70 or status device CPU/Power processor 37 with embedded Edge Server capabilities and transmitted by the Virtual Private Network 60 is enabled in the first case, by the first registration of the status device 30 by an individual 10 or customer support operator 82 during the registration process as contained within the applications 72 of the distributed computer system 70 or automatically by the CPU/Power processor 37 with embedded Edge Server capabilities in that case where remote activation may be desired.

The mode, selection, literal routing of the interface message created by the distributed computer system 70 and transmitted by the Virtual Private Network 60 is enabled in the second case, by the stored data of the Virtual Private Network 60 of an explicit location within that same Virtual Private Network 60 of the last know location of the status device 30 as represented by a request for location from an individual 10 or customer support operator 82 or as a result of the computer readable code for communications procedures as contained within the status device 30 that are employed to provide for the identification of the nearest telecommunication node and capability to communicate with that same node.

The creation, storage, access, construction of interfaces and transmission of interfaces containing data elements or otherwise, include the security and validation of all instructions for receiving the status and location of a status device 30 and the identification of person or object to which the device has been attached or assigned.

The distributed computer system 70 receives data elements and interfaces input from the status device 30 through the Virtual Private Network 60 utilizing cellular and wireless technologies that include the global position system data for the status device 30 attached or located on an individual or object 20; and makes the location and status data accessible by an individual, groups of individuals, or business entity 10 through various and multiple computer hardware devices 92, 93, 94.

In order to employ the functionality needed by an individual 10 user to identify, determine status, and locate track the status device 30 attached or associated to a person or object 20, the status device 30 may include a GPS chip 32 and wireless communication chip 35, 38 contained within an enclosure for reading information from a global positioning satellite system.

Global position satellites 40, generate signals which are received through the antennas 31 of and processed by the computer readable code contained within the GPS chip 32 generating and presenting those data elements which may include the longitude, latitude, and altitude of the status device 30 and, therefore, of the individual or object to which the device is associated.

In order to employ the functionality needed by an individual 10 user to identify and determine the status of a person or object 20, the status device 30 may include a biomedical sensor chip 36 contained within an enclosure for generating temperature or other electromagnetic information from the body of the person or object to which the status device 30 is attached.

The biomedical chip 36, generates signals which are received from and processed by computer readable code contained within the sensor chip 36 and generates and presents those data elements which may include but are not limited to temperature, electrocardiography, electroencephalography, or other biomedical electronic signals or frequency modulations of the person or object 20. The data elements from the biomedical sensor 36 are delivered to and processed by the computer readable code contained within the core logic of the GPS chip 32 and CPU/Power processor 37 with embedded Edge Server capabilities.

In order to employ the functionality needed by an individual 10 user to identify, and the determine status, of a person or object 20, the status device 30 may include a radio frequency identification or RFID chip 39 contained within an enclosure for generating identification of the person or object to which the status device 30 is attached.

The RFID chip 39, generates a radio frequency or RF signal which is received from and processed by computer readable code contained within the RFID chip 39 generates and presents those data elements which may include but are not limited to identification numbers which provide for the universally unique identification of the status device 30 and thus, the unique identification of the person or object to which the device is attached or assigned.

The data elements from the RFID chip 39 are delivered to and processed by the computer readable code contained within the core logic of the GPS chip 32. and are delivered to and processed by the computer readable code contained within the core logic of the GPS chip 32 and CPU/Power processor 37 with embedded Edge Server capabilities.

An additional feature of one embodiment of this invention is the literal information content of the RFID transmission interfaces and compliance of the construct and format of the RFID interface with the various and pertinent International Organization of Standardization RFID air interface, data, and quality standards. The provides for the present invention to establish and maintain compliance to and interoperability with those computer systems that are already deployed for RFID identification and status solutions that are operating in compliance to these same international standards organizations.

Once position information is calculated are delivered to and processed by the computer readable code contained within the core logic of the GPS chip 32, biomedical information is calculated are delivered to and processed by the computer readable code contained within the core logic of the GPS chip 32 and CPU/Power processor 37 with embedded Edge Server capabilities, and RFID identity information is calculated are delivered to and processed by the computer readable code contained within the core logic of the GPS chip 32, the computer readable code contained within the GPS chip 32 core logic and CPU/Power processor 37 presents all data elements to the wireless communication chips 35 and 38 for communications to the Virtual Private Network 60.

In order to employ the functionality needed by an individual 10 user to identify, and the determine status, of a person or object 20, the status device 30 may include a cellular or wireless communication chip 35, 38 contained within an enclosure for generating and receiving interfaces containing the information necessary for the status device 30 to locate and provide the status of the user or object 20 to which the device is attached or associated.

The computer readable code contained within the communications chip 34, 38 provides for the aggregation, assembly, and transformation of all data elements into interfaces that are then transmitted into the Virtual Private Network 60. It is this interface that contains all information concerning the location and status of the status device 30 and thus, the person or object to which the device is attached or assigned.

A number of location and status data elements can be dynamically stored within the memory of the CPU/Power processor 37 with embedded Edge Server capabilities. The purpose of storing these data elements is to provide the means for calculating and communicating the history of the location and status of the device as disclosed in the above application.

In order to employ the functionality needed by an individual 10 user to identify, and the determine status, of a person or object 20, the status device 30 may include a single or multiple batteries 33 which have extended shelf-live and may be of lithium or thin-film technology, or any other technology that is deemed appropriate and necessary to provide operating power to the device. The battery or batteries 33 are contained within an enclosure for generating power to all required components 31, 32, 34, 35, 36, 37, and 38. The RFID chip 39 may not necessarily require power to function to design.

A CPU/Power processor 37 chip employs computer readable code within the core logic of the regulator and within the enclosure to provide for all power setting, regulation, control, and conservation of power throughout the device. The CPU/Power processor 37 with embedded Edge Server capabilities includes the monitoring and evaluation of power remaining on within the batteries 33 including the delivery of data elements that represent remaining power availability as a percentage of total battery life. This data representation is determined within the CPU/Power processor 37 chip and provided to the core processor of the GPS chip 32 for inclusion as a data element within the interface as described above.

The CPU/Power processor 37 chip employs computer readable code that enables all components of the device that require power to operate in multiple power settings such as active, stand-by, or inactive.

This invention includes the provision that the power supply 33 may be non rechargeable and will eventually fail and that all components, functions, and capabilities disclosed within this invention will no longer be able to operate as designed due to complete loss of power. As the remaining power percentage data element reaches a predetermined level of total battery power, a unique data element is delivered to the CPU/Power processor 37 chip core logic that results in a specific data element being delivered from the GPS chip 32 to the wireless communication chips 34, 38 that result in an interface being created and delivered to the Virtual Private Network 60 indicating the status device 30 is in a low, critical, or out of power state. Therefore, an individual 10 is aware of and can determine that the state of power of the status device 30.

The status device 30 receives and transmits a very small interface containing limited data elements; in example an amount of data that may be represented in terms of standard computer readable code, as 128-bits, or sixteen-bytes, or sixteen human readable characters. The power setting and requirements for locating and determining status may be digital or analog in format and expressly exclude voice, video, or other media streaming data content and are significantly less than that data content or power requirements of common cellular telephones, personal computer assistants. With this advantage as well as eliminating the need for voice, video, or other non data explicit communications, the status device 30 batteries 33 consume significantly less power and are significantly smaller than those power supplies most often used by other GPS, cellular, personal computer, or telephonic devices.

The data content of the transmission interfaces includes the ability of explicitly and uniquely communicating a broad range of information includes but is not limited to: unique device identification, last known geographical location and altitude, level of power of the status device 30, command execution, command execution compliance, Electronic Product Code, Electronic Product Global Manager identification, Product Class designator, and unique data transmission identifier. An additional feature contained within one embodiment of the present invention is that the actual information content of the transmission interfaces are in compliance of the construct and format of such interfaces with the various and pertinent International Organization of Standardization air interface, data, and quality standards. This is better than what is taught in prior art wherein a partial data set or subset of information is transmitted within a nonstandard or proprietary interface. The improvement of the present invention over prior art is compliance to and interoperability with those computer systems that are already deployed for identification and status solutions. In example, the invention can easily be integrated into and made compatible with the numerous agencies and organizations having automated missing persons systems such as Amber Alert. Also, the ability to integrated location, time, and status information into commercial transportation, track and trace, and other enterprise wide applications and application suites is an inherent characteristic and further advantage of this invention.

In order to employ the functionality needed by an individual 10 user to identify, and the determine status, of a person or object 20, the distributed computer system 70 applications 72, are comprised of a set of computer readable instructions embodied in a computer readable medium that provide for the visual display of the data elements received from the status device 30 as a result of the request for status and location as described above.

The content of this visual display of data elements includes but is not limited to the literal geographic location of the status device 30 and thus, the person 20 or object to which that device has been attached or assigned, as represented in text characters, and also represented in the visual mapping of both current and historical information in the form of a graphical representation or graphical imagery of the specific location. A number of suitable graphical mapping applications incorporating all necessary programming features as described within this embodiment are commercially available and suitable for use with the present invention such as Google Maps. Such commercially available application is deployed as node within the Virtual Private Network 60 and is considered a distributed application set. Hence, the present invention should not be limited to any single manufacturer or commercially available graphical map.

Additional data element content of the visual display includes but is not limited to the historical location of the status device 30, complete identification of both the device and the person 20 or object to which the device has been attached or assigned, the most recent time, location and status of the device, and all known data elements that describe both the device, user 10, and person or object 20 to which the device is attached or assigned.

Although the description above contains many specifics, these should not be construed as limiting the scope of the invention but as merely illustrative of the various embodiments of the present invention, and various modifications can be made by those skilled in the art without departing from the scope and spirit of the invention. For example, the status device 30 can be in the form of a wristband as described here or in the form of any other object, such as a pendent, smart card, or earring. The same arrangement of components within the status device 30 could be incorporated within any design configuration. The status device 30 can be configured such that it has all of the features of the cellular communications module 34 in addition to its own features, with the exception of the secondary location feature. The status device 30 can also be configured with any combination of features rendered inoperative or inactive such as the RFID component 39 to reduce overall power consumption or meet explicit regulatory necessities. Thus the scope of this invention should be determined by the appended claims and their legal equivalents rather than by the examples given.

1. A system for obtaining location and status information for a person, animal or object comprising:
a) a distributed computer system having:
i) more than one databases; and
ii) more than one programmed application sets; and wherein the databases and programmed application sets are distributed across more than one physical data centers through an edge server;
b) a status device, having:
i) one or more component parts in substantially continuous communication with the distributed computer system;
ii) wherein the status device is worn by the person, animal or object; and
iii) wherein the status device communicates the location and status information to the distributed computer system through a virtual private network; and
c) a locator device, in communication with the distributed computer system through the virtual private network; wherein an entity desiring to locate the person, animal or object accesses the distributed computer system with the locator device through the virtual private network, and the distributed computer system is able to relay the location and status information provided by the status device to the locator device.

2. The system of claim 1, wherein the status device is a wristband.

3. The system of claim 1, wherein the status device is a pendant.

4. The system of claim 1, wherein the status device is a smart card.

5. The system of claim 1, wherein the status device is an earring.

6. The system of claim 1 further comprising a central support center, and wherein the central support center bridges the communication between the locator device and the distributed computer system.

7. The system of claim 6 wherein the central support center is staffed by one or more center operatives.

8. The system of claim 1, wherein the locator device is a computer.

9. The system of claim 1, wherein the locator device is a telephone.

10. The system of claim 1, wherein the locator device is a cellular phone.

11. The system of claim 1, wherein the locator device is a personal digital assistant (PDA).

12. The system of claim 1, wherein the status device also includes one or more non-component parts.

13. The system of claim 1, wherein the component parts include one or more parts selected from the group consisting of: a GPS antenna array, a GPS processor, a CPU/Power microprocessor, a communication processor.

14. The system of claim 1 wherein the status device includes a battery.

15. The system of claim 14, wherein the battery is selected from the group consisting of: lithium batteries, thin-film batteries, rechargeable batteries, non-rechargeable, and solar rechargeable batteries.

16. A method for providing location and status information for a person, animal or object to a searching entity comprising:
a) providing a distributed computer system having:
i) more than one databases; and
ii) more than one programmed application sets; and wherein the databases and programmed application sets are distributed across more than one physical data centers through an edge server;
b) affixing a status device to the person, animal or object, wherein the status device includes:
i) one or more component parts in substantially continuous communication with the distributed computer system; and
ii) wherein the status device communicates the location and status information to the distributed computer system through a virtual private network; and
c) providing a locator device to the searching entity, wherein the locator device is in communication with the distributed computer system through the virtual private network;
d) requesting the status and location information be provided from the distributed computer system to the locator device;
e) receiving the status and location information from the locator device.

17. The method of claim 16, wherein the status device is a wristband.

18. The method of claim 16, wherein the status device is a pendant.

19. The method of claim 16, wherein the status device is a smart card.

20. The method of claim 16, wherein the status device is an earring.

21. The method of claim 16 further comprising a central support center bridging the communication between the locator device and the distributed computer system.

22. The method of claim 21 wherein the central support center is staffed by one or more center operatives.

23. The method of claim 16, wherein the locator device is a computer.

24. The method of claim 16, wherein the locator device is a telephone.

25. The method of claim 16, wherein the locator device is a cellular phone.

26. The method of claim 16, wherein the locator device is a personal digital assistant (PDA).

27. The method of claim 16, wherein the status device also includes one or more non-component parts.

28. The method of claim 16, wherein the component parts include one or more parts selected from the group consisting of: a GPS antenna array, a GPS processor, a CPU/Power microprocessor, a communication processor.

29. The method of claim 16 wherein the status device includes a battery.

30. The method of claim 29, wherein the battery is selected from the group consisting of: lithium batteries, thin-film batteries, rechargeable batteries, and solar rechargeable batteries.
